(19) United States
(12) Patent Application Publication
(10) Pub. No.: US 2007/0291275 A1
(43) Pub. Date: Dec. 20, 2007

(54) Side-viewing optical acoustic sensors and their use in intravascular diagnostic probes

(75) Inventor: Paul Diamond, Fort Lee, NJ (US)

Correspondence Address: PATTON BOGGS LLP, 8484 WESTPARK DRIVE, SUITE 900, MCLEAN, VA, 22102, US

(73) Assignee: Prescient Medical, Inc., Doylestown, PA (US)

(21) Appl. No.: 11/808,374

(22) Filed: Jun. 8, 2007

Related U.S. Application Data
(60) Provisional application No. 60/814,059, filed on Jun. 16, 2006.

(51) Int. Cl. G01B 9/02

(52) U.S. Cl. 356/480

(57) ABSTRACT

One aspect of the invention provides side-sensing optical fiber-based optical acoustic sensors that are well suited to catheter-based intravascular diagnostic applications. Another aspect of the invention provides intravascular probes, such as catheters, that include a side-sensing optical acoustic sensor according to the invention and means for photoacoustically generating an acoustic signal, such as ultrasound, from a target tissue. Still another aspect of the invention provides a method for evaluating at least a section of a blood vessel, such as an artery, and in particular identifying, locating and/or characterizing atherosclerotic lesions within the blood vessel. A related embodiment provides a method for identifying, locating and/or characterizing lipid-rich atherosclerotic lesions such as vulnerable plaques.

This application claims the benefit of U.S. provisional patent application Ser. No. 60/814,059 filed Jun. 16, 2006, which is incorporated by reference herein in its entirety.

### FIELD OF THE INVENTION

The invention relates generally to the fields of optical acoustic sensors and photoacoustic stimulation.

### BACKGROUND OF INVENTION

Various modalities for diagnostically interrogating blood vessel walls to locate and characterize atherosclerotic lesions have been described. Intravascular ultrasound (IVUS) is one method for examining blood vessels. Piezoelectric effect-based ultrasound detectors are well known in the art. More recently, optical ultrasound sensors, such as Fabry-Perot interferometers, have been described. Advantageously, these optoacoustic-type sensors can be integrated with or combined with optical fibers in probes, such as catheters. One type of Fabry-Perot interferometer includes a polymeric interferometer film, the deflection or compression of which, by a signal for analysis (such as an ultrasound signal), modulates multiple reflections of an incident optical interrogation signal. For example, one optical fiber interferometer known in the art uses includes an optical fiber having a cleaved end and a polymer sensing film butted against the cleaved end. The opposite faces of the polymer film provide the two reflecting surfaces of the interferometer. Light is introduced to the optical fiber and any external change that causes a variation in the optical thickness of the sensor film can be detected, since modulation of the thickness of the polymer film influences the output of the interferometer sensor. The external changes could include acoustic waves, quasi-static pressure and temperature variations or thermal waves caused by transient heating. Another type of Fabry-Perot interferometer includes opposing mirrors; any change in the distance between the mirrors modulates the interrogation signal. For example, one such Fabry-Perot interferometer known in the art includes opposing mirror surfaces that are formed within an optical fiber by deposition of reflective materials into axial positions along the fiber.

A target for interrogation may also be optically induced to generate ultrasound by the photoacoustic effect. Pulsed laser irradiation is typically used to induce ultrasonic waves in a tissue target. U.S. Pat. No. 6,839,496 discloses optical fiber probes for photoacoustic material analysis, and is incorporated by reference herein in its entirety. The patent teaches an integrated optical fiber-based apparatus for photoacoustically inducing the generation of an acoustic signal by a target and detecting the generated acoustic signal using a Fabry-Perot interferometer provided on the end of the fiber. More specifically, the patent discloses optical fibers including an outer core for carrying excitation light for photoacoustic stimulation of a target and an inner core for transmitting and receiving light from a Fabry-Perot interferometer film provided on the target-interrogating end of the optical fiber. However, this patent fails to teach how side-sensing (radial field sensing) with respect to the axis of the optical fiber can be achieved.

The following patents and publications are also background to the present invention.

U.S. Pat. No. 5,840,023 discloses systems and methods of acoustic imaging for medical diagnosis, and is incorporated by reference herein in its entirety.

U.S. Pat. No. 6,281,976 discloses fiber-optic Fabry-Perot interferometer sensors and methods of measurement therewith, and is incorporated by reference herein in its entirety. However, this patent fails to teach how side-sensing (radial field sensing) with respect to the axis of the optical fiber can be achieved.

U.S. Pat. No. 6,445,939 discloses ultra-small optical probes that include an optical fiber and a lens that has at least substantially the same diameter as the fiber and which may be in communication with a beam director, and is incorporated by reference herein in its entirety.

U.S. Pat. No. 6,522,913 discloses systems and methods for visualizing tissue during diagnostic or therapeutic procedures that utilize a support structure that brings sensors into contact with the lumen wall of a blood vessel, and is incorporated by reference herein in its entirety.

U.S. Pat. No. 6,701,181 discloses multi-path optical catheters, and is incorporated by reference herein in its entirety.

U.S. Pat. No. 6,813,401 discloses methods for fabricating Fabry-Perot polymer film sensing interferometers on optical fiber substrates, and is incorporated by reference herein in its entirety. However, this patent fails to teach how side-sensing (radial field sensing) with respect to the axis of the optical fiber can be achieved.

U.S. Pat. No. 6,873,868 discloses multi-fiber catheter probe arrangements for tissue analysis or treatment, and is incorporated by reference herein in its entirety.

U.S. Pat. No. 6,949,072 discloses devices for vulnerable plaque detection, and is incorporated by reference herein in its entirety.

U.S. Publication No. 2002/0183622 discloses a fiber-optic apparatus and method for the optical imaging of tissue samples, and is incorporated by reference herein in its entirety.

U.S. Publication No. 2003/0125630 discloses catheter probe arrangements for tissue analysis by radiant energy delivery and radiant energy collection, and is incorporated by reference herein in its entirety.

U.S. Publication No. 2004/0204651 discloses infrared endoscopic balloon probes, and is incorporated by reference herein in its entirety.

U.S. Publication No. 2004/0260182 discloses intraluminal spectroscope devices with wall-contacting probes, and is incorporated by reference herein in its entirety.

U.S. Publication No. 2005/0054934 discloses an optical catheter with dual-stage beam redirector, and is incorporated by reference herein in its entirety.

U.S. Publication No. 2005/0075574 discloses devices for vulnerable plaque detection that utilize optical fiber temperature sensors, and is incorporated by reference herein in its entirety.

U.S. Publication No. 2005/0165315 discloses a side-firing fiber-optic array probe, and is incorporated by reference herein in its entirety.

In view of the above, what is needed and desirable are improved optoacoustic sensors that are adapted for side (lateral) viewing applications and also integrated probes that include both the improved sensor and photoacoustic stimulating means.

### SUMMARY OF INVENTION

The present invention provides side-viewing optical acoustic probes that employ Fabry-Perot interferometers.

One aspect of the invention provides a side-sensing optical acoustic probe, that includes: an optical fiber having a proximal end and a distal end and a central axis; a light redirecting element, such as prism or a mirrored optical element, having a sensing-side face and a fiber-side face, the light directing element being in optical communication with the distal end of the fiber via the fiber-side face; and a side-facing Fabry-Perot interferometer element in optical communication with the light redirecting element via the sensing-side face of the light redirecting element.

Other aspects of the invention provide, for example, side-sensing intravascular guidewires and intravascular catheters that include at least one side viewing optical acoustic probe.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

FIG. 1 shows a side-viewing Fabry-Perot interferometer-based optical acoustic detector embodiment of the invention.

FIG. 2 shows a side-viewing Fabry-Perot interferometer-based optical acoustic detector embodiment of the invention having a radial extension zone.

FIG. 3 shows an embodiment of the invention incorporating a film-type Fabry-Perot interferometer.

FIG. 4 shows an embodiment of the invention incorporating an etalon-type Fabry-Perot interferometer.

FIG. 5A shows a multi-fiber probe embodiment of the invention.

FIG. 5B shows the head detail of a variation of the embodiment shown in FIG. 5.

FIG. 6 shows an embodiment in which a side-viewing Fabry-Perot interferometer-based acoustical detector is housed in an elongate housing.

FIG. 7 shows an embodiment in which a side-viewing Fabry-Perot interferometer-based acoustical detector is housed in an elongate housing and the acoustical receiving surface is slightly recessed from the surface of the housing.

FIG. 8 shows a head-on view (with respect to the acoustical receiving surface) of the embodiment of FIG. 6 or FIG. 7.

FIG. 9 shows a prior art, basket-style optical intravascular catheter.

FIG. 10 shows further detail of a prior art, basket-style optical intravascular catheter.

### DETAILED DESCRIPTION

The present invention provides side-viewing optical acoustic probes that employ Fabry-Perot interferometers.

The invention is further described below with reference to the appended figures.

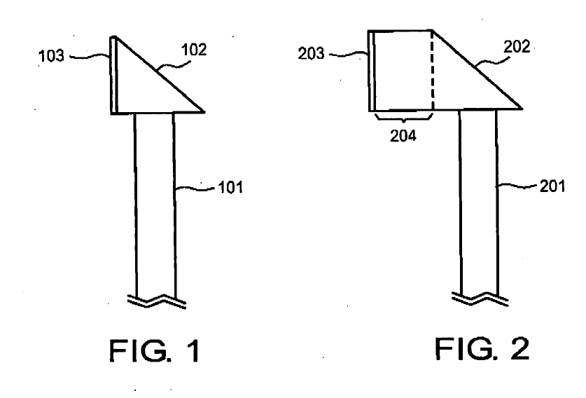

FIG. 1 shows a side-viewing Fabry-Perot interferometer-based optical acoustic detector embodiment of the invention. Member 101 is an optical fiber, the distal end of which is in optical communication with a light redirecting element 102 on which a Fabry-Perot type interferometer 103 is directly or indirectly disposed. Light redirecting element may, for example, be a prism or a mirror, such as a mirror face on a support. In the detector's operative state, the proximal end of optical fiber 101 (not shown) is in communication with a light source such as a laser, a light detector and an analyzer, such as a computer.

FIG. 2 shows a side-viewing Fabry-Perot interferometer-based optical acoustic detector embodiment of the invention having a radial extension zone 204. The embodiment shown in FIG. 2 is similar to that of FIG. 1, except that in FIG. 2 acoustical signal-sensing face provided by the Fabry-Perot interferometer 203 is extended away from the reflecting face of the light redirecting element 202. The radial extension zone 204 may be an integral part of the light redirecting element 202 and/or it may be composed of one or more separate optical elements joined to the light redirecting element 202.

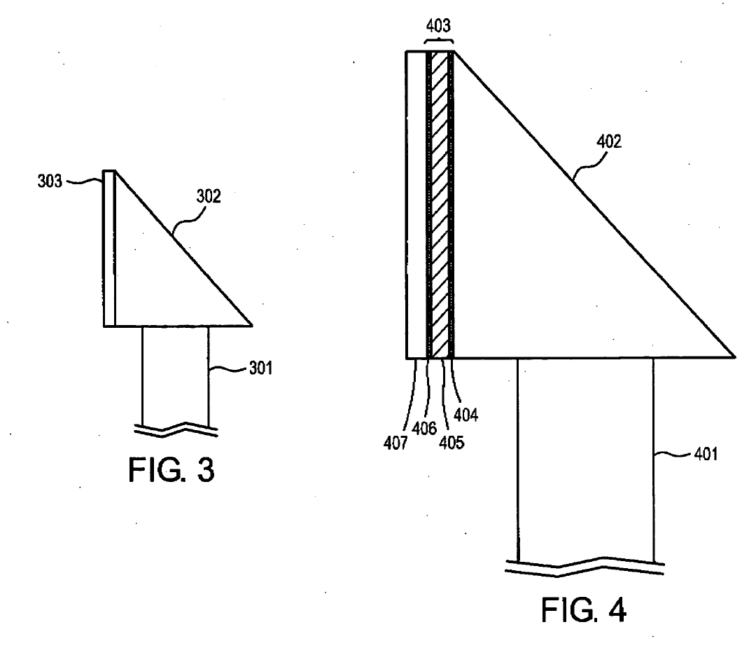

FIG. 3 shows an embodiment of the invention incorporating a film-type Fabry-Perot interferometer. In a film-type Fabry-Perot interferometer, the two opposing sides of a thin film act as reflecting surfaces.

The Fabry-Perot interferometer film 303 may, for example, be formed directly onto the sensor-face side of the light redirecting element 302 according to the method of U.S. Pat. No. 6,813,401, which is incorporated by reference herein. The sensor face side of the light redirecting element 302 (or other substrate) may, for example, be coated with parylene to form an interferometer film of uniform thickness. Light redirecting element 302 may or may not be joined to optical fiber 301 when the deposition of film 303 occurs. Surfaces may be masked off to prevent unwanted deposition of film.

In one suitable method, a dimer parylene precursor is introduced into an inlet chamber via tubing where it is vaporized at approximately 150 degree C. in a 100 Pa vacuum. The vaporized dimer continues via tubing to a pyrolysis chamber where it is heated to a temperature of approximately 680 degree C. in a 50 Pa vacuum. The highly active parylene monomer gas continues via tubing to a deposition chamber where the articles for coating are located. The deposition chamber may be at ambient room temperature and at a weak vacuum pressure, for example having an internal pressure of around 10 Pa. The monomer simultaneously condenses, adsorbs and polymerizes on all available surfaces to produce a high molecular-weight polymer coating. Due to the chemical properties of para-xylylene and the polymerization mechanism, the coating formed is conformal and has uniform thickness. In particular, the parylene deposition process does not entrap air since the process is carried out in an effective vacuum. The coating thickness can then be checked. A wide range of thicknesses of the polymer film can be achieved, for example from 0.025 microns to 75 microns, with high thickness tolerance due to the controllable nature of the process. Solvents may be used to remove surface contaminants such as oils and ions from the component surfaces prior to the coating process perform the cleaning process. A multi-molecular layer of an organo-silane may also be applied to pretreat the component surfaces that are to be coated. This functions as an adhesion promoter, allowing the polymers to be applied to virtually any vacuum stable material.

Film-type Fabry-Perot interferometers may, for example, also be more conventionally but less preferably formed by using a preformed piece of PET (polyethylene terepthalate) as the polymer film. A disc or other shape may be cut from a larger sheet of the PET having a known thickness and adhered to the sensor-face side of the light redirecting element 303 using an optically-acceptable adhesive agent.

FIG. 4 shows an embodiment of the invention incorporating an etalon-type Fabry-Perot interferometer. The sensor face side of light redirecting element 402 is a substrate for the interferometer 403. The etalon structures may, for example, be formed according to the method of Ashkenazi et al. (2005) High frequency ultrasound imaging using Fabry-Perot optical etalon Proc. of SPIE (5750) 289-297, which is incorporated by reference herein in its entirety. Interferometer 403 may be formed by depositing a first gold mirror 404, then a transparent separating layer 405, such as a 10 micron layer of SU-8 polymer, and then a second gold mirror 406. A protective polymer layer 407 may also be deposited. The protective layer 407 may, for example, be a 1.5 micron coating of SU-8 polymer. The gold mirrors may be formed by vacuum evaporation. The bulk of the etalon may be formed by spin coating an SU-8 polymer solution (epoxy-based photoresist; Microchem Inc., Newton, Mass. USA). The protective layer may be formed by a final coating with SU-8.

The methods of forming Fabry-Perot interferometers described for FIGS. 3 and 4 may also be used in connection with the type of embodiment shown in FIG. 2.

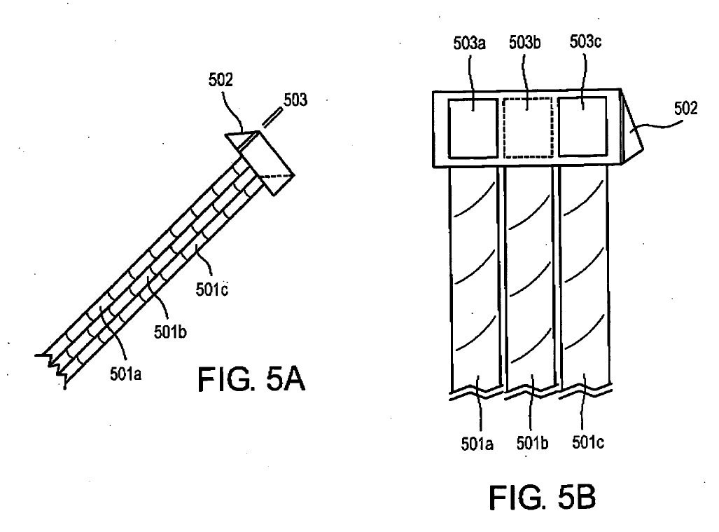

FIG. 5A shows a multi-fiber probe embodiment of the invention. The distal end of each of three optical fibers 501a, 501b and 501c are aligned in a flat, side-by-side fashion and are in optical communication with a single light redirecting element 502. A Fabry-Perot interferometer 503 is disposed on at least part of the sensor-face surface of the light redirecting element 502 so that at least one of the optical fibers forms an optical detector in conjunction with the light redirecting element 502 and the interferometer 503.

FIG. 5B shows the head detail of a variation of the embodiment shown in FIG. 5. Fabry-Perot interferometers 503a and 503c are in optical communication with fibers 501a and 501c, respectively, via light redirecting element 502. Region 503b does not have a Fabry-Perot interferometer. Instead, optical fiber 501b is used to optically induce a target to generate an acoustic signal such as ultrasound by the photoacoustic effect. Accordingly, in operation, fiber 501b will be in optical communication with a pulsed laser source at or near its distal end. Region 503b may have a lens or other focusing optics associated therewith to focus and/or shape the photoacoustic excitation light. Ultrasound signals generated from a target, such as a target biological tissue, as a result of photoacoustic stimulation can be detected by the interferometer channels associated with fibers 501a and 501c.

Although the multi-fiber embodiment shown in the FIG. 5B has three fibers, it should be understood that the invention also provides similar probes having two fibers, i.e., one interferometer channel and one photoacoustic excitation channel, as well as probes having more than three fibers.

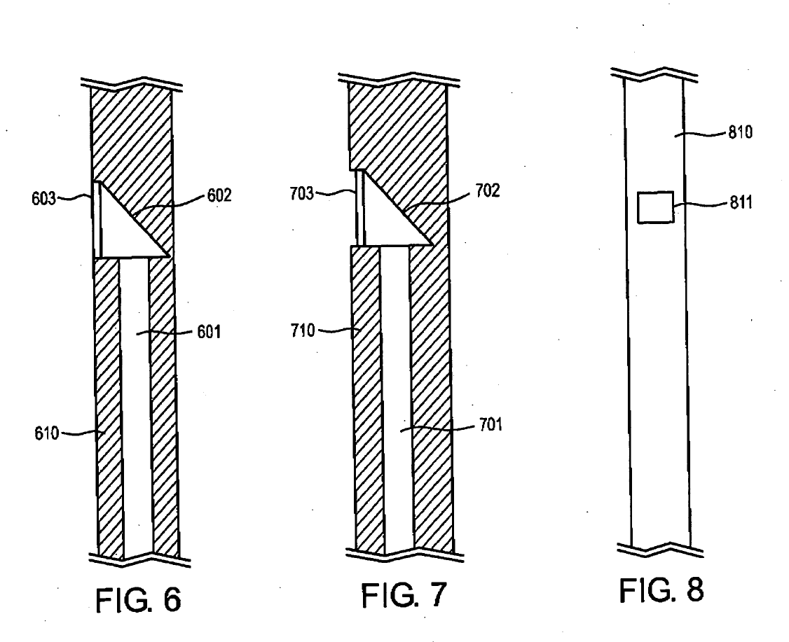

FIG. 6 shows an embodiment in which a side-viewing Fabry-Perot interferometer-based acoustical detector is housed in an elongate housing 610. The housing may, for example, be a diagnostic guidewire or catheter, such an intravascular diagnostic guidewire or intravascular diagnostic catheter, or an arm or projection thereof. The sensor face of the probe as shown is at least substantially flush with outer surface of the housing.

FIG. 7 shows an embodiment in which a side-viewing Fabry-Perot interferometer-based acoustical detector is housed in an elongate housing 710 and the acoustical receiving surface is slightly recessed from the surface of the housing

FIG. 8 shows a head-on view (with respect to the acoustical receiving surface) of the embodiment of FIG. 6 or FIG. 7. An opening (aperture) 811 is present in housing 810 by which access of the sensor face of the probe to the environment is provided. The housing 810 is shown as solid in this figure; accordingly the optical fiber(s) and light redirecting element are not visible.

The embodiments shown in FIGS. 6-8 may have a single optical fiber or may have two or more optical fibers.

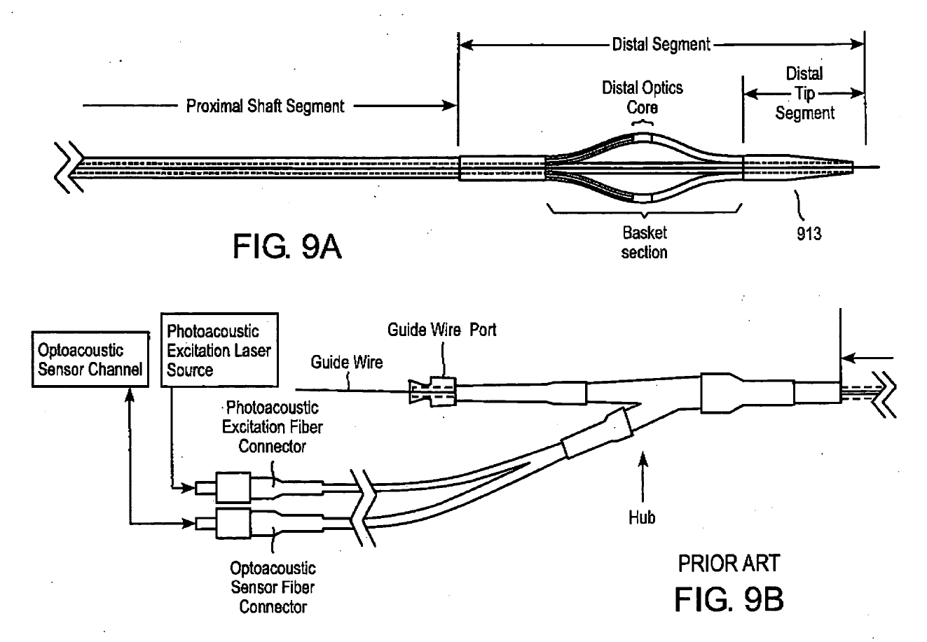

FIG. 9 shows a prior art, basket-style optical intravascular catheter 913. The catheter shown has an over-the-wire configuration wherein a guidewire lumen runs the length of the catheter. Other guidewire lumen configurations, such as those that only run part of the length of the catheter, are also possible. The optical fibers begin within each sensor core and extend to the proximally to the connectors. FIG. 9 also shows the proximal hub and connectors that may be used for connecting the fibers to a laser source for photoacoustic stimulation and to a laser-analyzer unit for ultrasound detection and analysis via the optoacoustic sensor (Fabry-Perot interferometer) fiber channel(s).

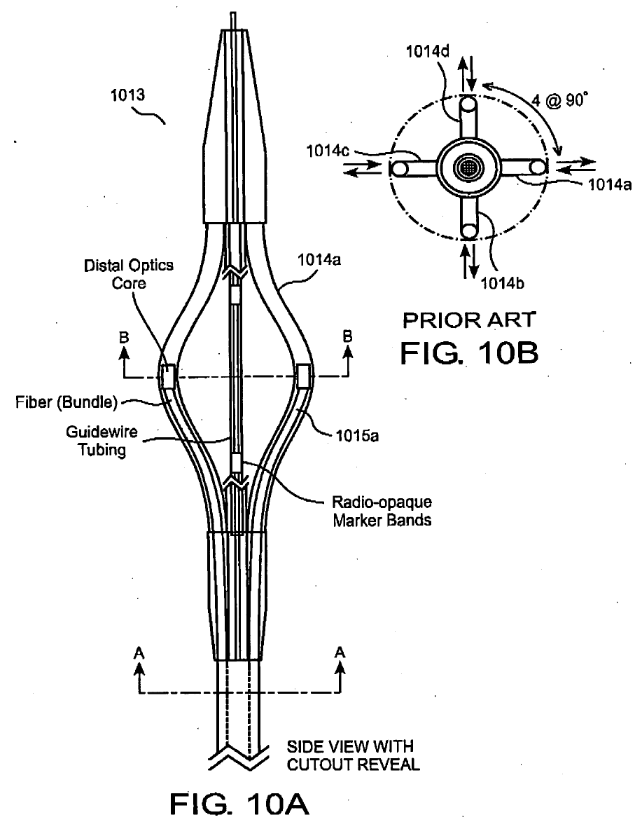

FIG. 10 shows further detail of a prior art, basket-style optical intravascular catheter 1013. The catheter shown has four outwardly flexing arms 1014a-d. As shown for arm 1014a, each arm has disposed therein a side-viewing optical acoustic probe 1015a according the invention. The radially outward disposition of the arms 1014 brings the distal ends of the optical probes 1015 near or into contact with a lumen wall, such as a blood vessel wall, in order to detect acoustic signals, such as ultrasound, that originate from or interact with the target being examined. The target may, for example include, the lumen wall itself and/or matter or tissue disposed beyond the lumen wall. A side-viewing optical probe 1015 may include one or more optical fibers and may have one or more channels for the photoacoustic excitation of a target. The outward radial extension of the arms with respect to the axis of the catheter may be controlled, for example by relative movement of the distal end of the arms (which are attached to the distal end of the catheter) with respect to proximal end of the basket section.

The optical acoustic probes and related embodiments of the invention are well suited to the intravascular evaluation and diagnosis of blood vessels for healthy and atherosclerotic states, such as vulnerable plaque. Vulnerable plaques, which are sometimes known as high-risk atherosclerotic plaques, are arterial atherosclerotic lesions characterized by a subluminal thrombotic lipid-rich pool of materials contained by a thin fibrous cap. Although vulnerable plaques are non-stenotic or nominally stenotic, it is believed that their rupture, resulting in the release of thrombotic contents, accounts for a significant fraction of adverse cardiac events.

One embodiment of the invention provides a method for evaluating a blood vessel that includes the steps of: detecting ultrasound signals emanating from a blood vessel wall or matter or tissue beyond the wall using an intravascularly disposed optical acoustic probe according the invention; and analyzing the detected signals. In one variation, the step of analyzing includes analyzing the signals to determine the presence or absence of a lipid rich deposit and/or a vulnerable plaque lesion.

A related embodiment of the invention provides a method for evaluation of a blood vessel that includes the steps of: photoacoustically stimulating a blood vessel wall or matter or tissue beyond the wall; detecting the photoacoustically generated acoustic signals from the blood vessel wall or matter or tissue beyond the wall using an intravascularly disposed optical acoustic probe according the invention; and analyzing the detected signals. In one variation, the photoacoustic stimulation is performed by directing light from within the lumen of the vessel toward the target. In one variation, the probe has at least one channel for the photoacoustic stimulation of the target. In one variation, the step of analyzing includes analyzing the signals to determine the presence or absence of a lipid rich deposit and/or a vulnerable plaque lesion.

One embodiment of the invention provides an integrated system for evaluating a blood vessel, for example, for diagnosing and/or locating vulnerable plaque lesions in an artery, that includes an optical guidewire or catheter including at least one Fabry-Perot interferometer optical acoustic probe according to the invention, in communication with a light source such as a laser, a light detector and an analyzer such as a computer for analyzing signals from the interferometer. One or more computers, or computer processors generally working in conjunction with computer accessible memory and computer instructions therein, may be part of the system for controlling the system and/or for analyzing information obtained by the system. A related embodiment further includes at least one channel for photoacoustically exciting a target and a pulsed laser source for the photoacoustic excitation. A variation of the embodiment further includes a controller for the pulsed laser source.

Each of the patents and other publications cited in this disclosure is incorporated by reference in its entirety.

Although the foregoing description is directed to the preferred embodiments of the invention, it is noted that other variations and modifications will be apparent to those skilled in the art, and may be made without departing from the spirit or scope of the invention. Moreover, features described in connection with one embodiment of the invention may be used in conjunction with other embodiments, even if not explicitly stated above.

What is claimed is:

1. A side-sensing optical acoustic probe, comprising:
an optical fiber having a proximal end and a distal end and a central axis;
a light redirecting element having a sensing-side face and a fiber-side face, the light directing element being in optical communication with distal end of the fiber via the fiber-side face; and
a side-facing Fabry-Perot interferometer element in optical communication with the light redirecting element via the sensing-side face of the light redirecting element.

2. The probe of claim 1, wherein the light redirecting element is a prism.

3. The probe of claim 2, wherein the light redirecting element is a 45-degree prism.

4. The probe of claim 1, wherein the light redirecting element comprises a mirror face.

5. The probe of claim 4, wherein the light redirecting element comprises a 45-degree mirror face.

6. The probe of claim 1, wherein the Fabry-Perot interferometer element consists essentially of a thin-film.

7. The probe of claim 6, wherein the thin-film is polymeric.

8. The probe of claim 1, wherein the Fabry-Perot interferometer element is an optical etalon Fabry-Perot interferometer.

9. The probe of claim 8, wherein the Fabry-Perot interferometer element consists essentially of two mirror elements separated by a transparent layer element.

10. The probe of claim 8, further comprising a protective outer coating over the Fabry-Perot interferometer element.

11. The probe of claim 9, further comprising a protective outer coating over the Fabry-Perot interferometer element.

12. The probe of claim 1, wherein the distal end of the optical fiber is directly or indirectly joined to the fiber-side face of the light redirecting element.

13. The probe of claim 1, wherein Fabry-Perot interferometer element is directly or indirectly disposed on the sensing-side face of the light redirecting element.

14. The probe of claim 13, wherein the distal end of the optical fiber is directly or indirectly joined to the fiber-side face of the light redirecting element.

15. The probe of claim 1, further comprising a photoacoustic excitation channel for inducing ultrasound in a side-disposed target.

16. The probe of claim 15, wherein the photoacoustic excitation channel comprises a separate excitation optical fiber in optical communication with the same or a different light redirector.

17. A diagnostic guidewire comprising:
a guidewire body; and
at least one optical probe according to claim 1 at least substantially disposed within the guidewire body.

18. An intravascular catheter comprising:
an intravascular catheter body; and
at least one optical probe according to claim 1 at least substantially disposed within the guidewire body.
